(19) United States
(12) Patent Application Publication
(10) Pub. No.: US 2013/0062368 A1
(43) Pub. Date: Mar. 14, 2013

(54) Finish Dispensing Apparatus

(71) Applicant: Lane D. Strode, LaConner, WA (US)

(72) Inventor: Lane D. Strode, LaConner, WA (US)

(21) Appl. No.: 12/436,767

(22) Filed: May 6, 2009

(51) Int. Cl. B67D 3/00

(52) U.S. Cl. 222/192

(57) ABSTRACT

The invention disclosed herein is a floor finish dispensing apparatus. The apparatus defines a wheeled carriage mounted storage tank having a dispensing nozzle, a handle bar, and a control handle capable of controlling the flow rate of a liquid that is dispended from the storage tank. The apparatus is especially useful in efficiently and easily dispensing large quantities of floor finish such as Castlegaurd and Shurgloss 25 floor finishes at desired locations and in desired patterns such as elongated “puddle” finish patterns without overspray, finish splatter, finish waste, or user fatigue.

### BACKGROUND

The present invention relates generally to machines that apply liquid chemicals. More particularly, the present invention relates to machines that apply liquid floor finish products.

### RELATED ART

A variety of liquid dispensing machine and devices have long existed. Many such machines and devices are used in the floor cleaning, treating, and finishing industries. Many of the machines and devices include electrical motors or combustion engines, pressurized spray systems, spraying booms, and other complex features. Examples of such concepts are disclosed in the following US patents. US patent applications, and published references which are incorporated herein by reference in their entirety: U.S. Pat. Nos. 7,223,038, 7,185,397, 7,048,458, 6,976,802, 6,467,983, 6,325,563, 6,227,744, 6,015,097, 4,260,273, 4,124,315, 4,119,386, 3,981,596, RE29,639, 20070294854, 20060280546, 20060236494, 20060228160, Aztec Products Liquidator Model 520, Eagle Solutions Solution Spreaders, and Tennant Model 600. Furthermore, several floor finish compositions have been developed for use in creating a high luster and damage/scuff tolerant finish. While such finishes have increased in quality and utility over the years, such finishes are not inexpensive. Exemplary finishes include the following published specifications of finishes which are incorporated herein by reference in their entirety: Buckeye International Castleguard finish and Detco Industries ShurGloss 25 finish.

### SUMMARY

It has been recognized in the floor finishing industry that the application of floor finish in sufficient quantities and in an efficient time period while minimizing spillage and excess application of finish to a floor that is to be treated is a difficult and physically demanding task. Many of the above listed machines require motors or engines which increase the cost and reduce the reliability of the machine. Further, many such systems pressurize the finish resulting in over-spray of an expensive finish product. Further, such pressurized systems typically have correspondingly small finish application orifices which also result in increased machine clean-up difficulty. Given the lack of a machine that satisfies the needs of floor finish application, especially in the large or commercial floor finishing industry, many in the floor finishing industry have resorted to pouring floor finish by hand out of 1 gallon containers, directly onto the floor to be finished. Such application of floor finish is not only imprecise and inefficient, it can be very taxing and painful to the back of the person performing such manual floor finish application. The invention therefore is a floor finish application apparatus. The apparatus defines a wheeled carriage mounted storage tank having a dispensing nozzle, a handle bar, and a control handle capable of controlling the flow rate of a liquid that is dispended from the storage tank. The apparatus is especially useful in efficiently and easily dispensing large quantities of floor finish such as Castlegaurd and Shurgloss 25 floor finishes at desired locations and in desired patterns such as elongated “puddle” finish patterns without overspray, finish splatter, finish waste, or user fatigue.

### BRIEF DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a substantially trimetric view of a first embodiment of the present invention;

FIG. 2 is an enlarged view of the nozzle area of FIG. 1;

FIG. 3 is a substantially orthographic side view of a first embodiment of the present invention;

FIG. 4 is a substantially orthographic rear view of a first embodiment of the present invention; and

FIG. 5 is a substantially orthographic top view of a first embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The invention is a floor finish application apparatus having a wheeled carriage mounted storage tank, a dispensing nozzle, a handle bar, and a control handle capable of controlling the flow rate of floor finish or other liquid that are dispended from the storage tank capable of the apparatus. The apparatus is especially useful in dispensing floor finish and other liquids preferably in elongated puddles or a “trails” without over-spray or splatter of the finish and without undue strain on the back of the person dispensing the finish.

In order to facilitate the understanding of the present invention in reviewing the drawings accompanying the specification, a feature list is provided below. It is noted that like features are like numbered throughout all of the figures.

FEATURE TABLE

| # | Feature | # | Feature |
|---|---|---|---|
| 10 | Finish dispensing apparatus | | |
| 20 | Chassis assembly | 22 | Bed |
| 24 | Frame | 26 | Support arm |
| 30 | Handle bar assembly | 32 | Bar |
| 34 | Handle | 36 | Grip |
| 38 | Lever mount bracket | 39 | Pivot hole (not shown) |
| 40 | Cable mount bracket | 42 | Adjustment lever |
| 44 | Lever body | 46 | Pivot hole |
| 48 | Cable attach hole | 50 | Lever handle |
| 52 | Retainer pin | | |
| 60 | Hopper assembly | 62 | Hopper |
| 64 | Mouth | 66 | Cubic portion |
| 68 | Inverted pyramid portion | 69 | Base Plate |
| 70 | Exit port | 72 | Lid |
| 74 | Handle | | |
| 80 | Tube assembly | 82 | Attach nut |
| 84 | Straight tube | 86 | Valve assembly |
| 88 | Valve | 90 | Control lever |
| 92 | Attach nut | 94 | Elbow tube |
| 96 | Threaded end | 98 | Curved portion |
| 100 | Straight portion | 102 | Spout |
| 110 | Rear axle assembly | 112 | Axle |
| 114 | Wheel | | |
| 120 | Swivel caster assembly | 122 | Caster base |
| 124 | Caster shoe | 126 | Wheel |
| 130 | Control cable assembly | 132 | Control cable |
| 134 | Casing | 136 | Knob |
| 138 | Clevis | 140 | Retainer pin |
| 142 | Cotter Pin | | |
| 150 | Small U-bolt | 152 | Large U-bolt |
| 160 | Finish | 162 | Floor surface |
| 164 | Gap | | |

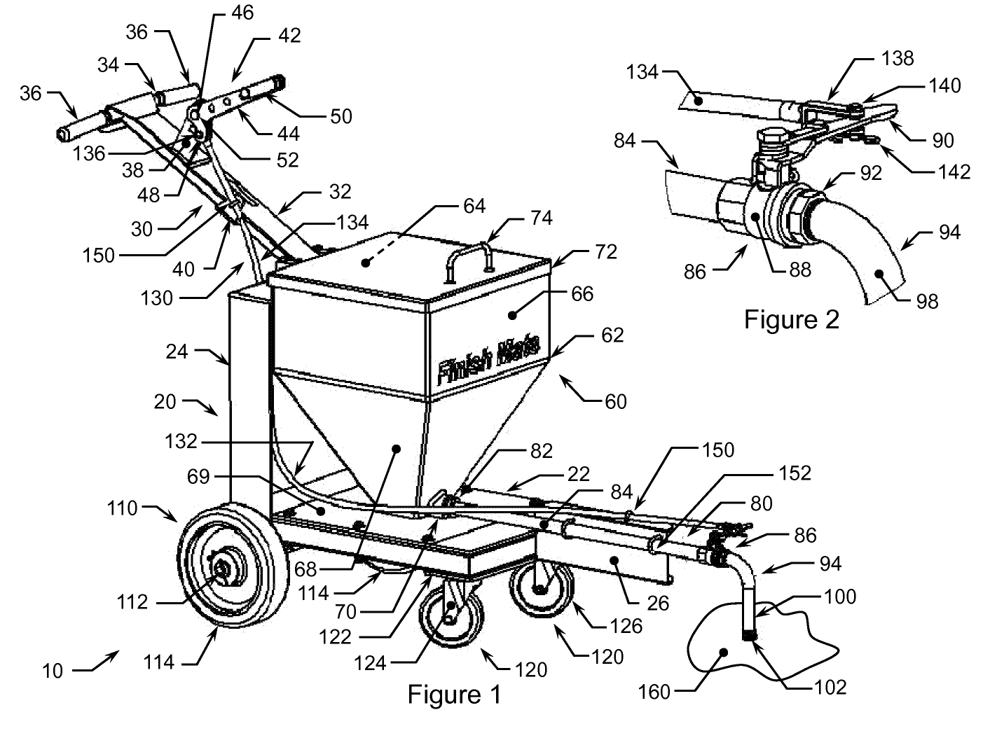

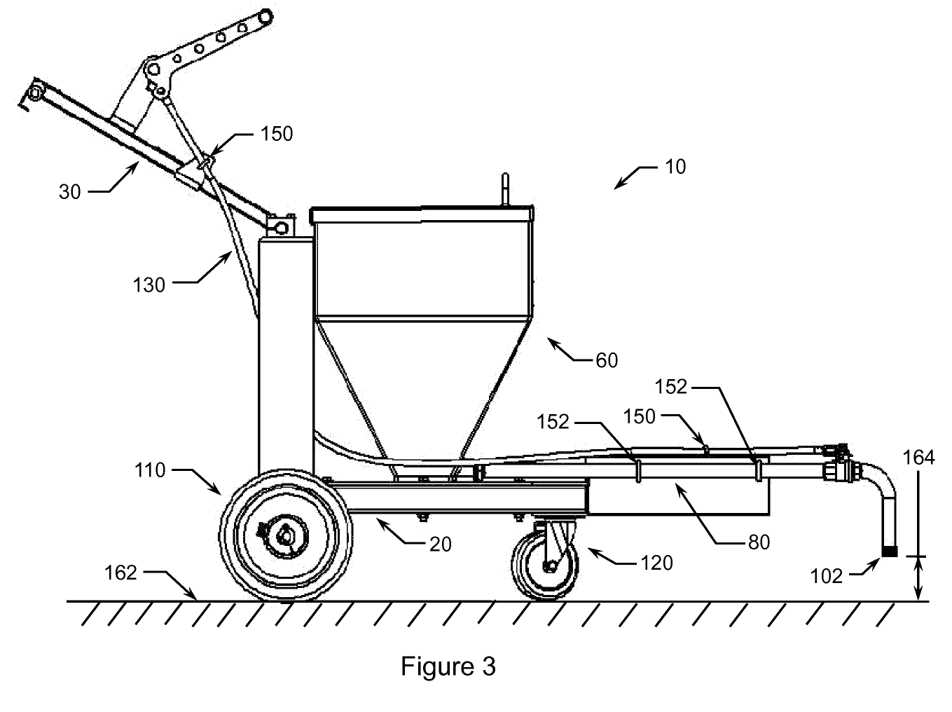

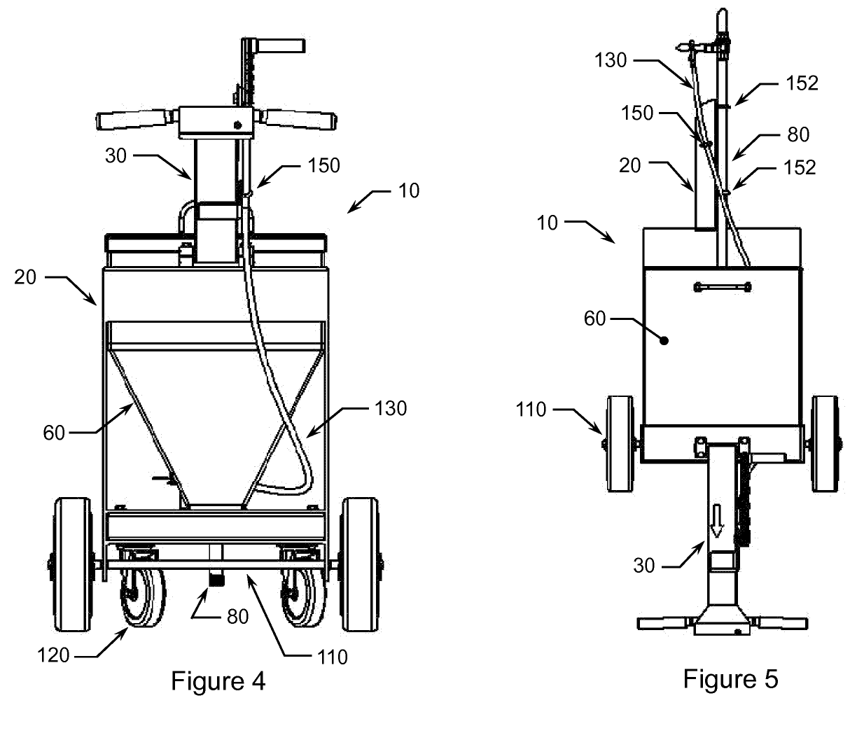

Referring now to the drawings and in particular to FIG. 1, a first embodiment of the invention is a finish dispensing apparatus 10 for use in dispensing finish 160 comprising a chassis assembly 20, a handle bar assembly 30, a hopper assembly 60, a tube assembly 80, a rear axle assembly 110, a plurality of swivel casters 120, a control cable assembly 130, a plurality of small U-bolts 150, and a plurality of large U-bolts 152. Chassis assembly 20 further defines a substantially flat bed 22, a generally “L” shaped frame 24 having a vertical portion and a horizontal portion, and a support arm 26. All of bed 22, frame 24, support arm 26, small U-bolts 150, and large U-bolts 152 are preferably constructed of metal such as steel or aluminum. Bed 22 is fastened to the horizontal portion of frame 24 and support arm 26 is cantileveringly connected to a front end of frame 24.

Handle bar assembly 30 further comprises an elongated bar 32, a tubular handle 34, a plurality of grips 36, a lever mount bracket 38, a cable mount bracket 40, an adjustment lever 42, and a cylindrical retainer pin 52. Adjustment lever 42 further defines a lever having a body 44 and a handle 50 extending from body 44. Lever mount bracket 38 further includes a pivot hole 39 (not shown), and lever body 44 further includes a pivot hole 46, and a cable attach hole 48. All of bar 32, handle 34, lever mount bracket 38, cable mount bracket 40, adjustment lever 42, and retainer pin 52 are preferably constructed of metal such as steel or aluminum. Grips 36 are preferably constructed of plastic or rubber and are such that the outer surface of grips 36 are flexible and have a substantially high coefficient of friction to provide for a proper grasping surface. Handle bar assembly 30 is assembled such that grips 36 are press-fit onto handle 34, handle 34 is fastened to a first end of bar 32, and brackets 38 and 40 are connected to a side surface of bar 32. Adjustment lever 42 is swivelably mounted to lever mount bracket 38 by means of retainer pin 52 being retainably inserted through pivot holes 39 and 46.

Hopper assembly 60 further comprises a hopper 62 and a removable and replaceable lid 72. Hopper 62 includes a mouth 64, a cubic portion, 66, an inverted pyramid portion 68, a base plate portion 69, and an exit port 70. Hopper 62 is configured such that mouth 64 is located at an upper end of cubic portion 66, inverted pyramid portion 68 is connected to a lower end of cubic portion 66, base plate portion 69 is connected to a lower portion of inverted pyramid portion 68, and exit port 7o form an exit port extending from a lower portion of inverted pyramid portion 68. Hopper 62 preferably has a volumetric capacity of 10 gallons such that hopper 62 may store 10 gallons of finish 160 but hopper 62 may have a volumetric capacity of greater or lesser than 10 gallons such as a capacity in the range of two gallons to 25 gallons. Lid 72 further defines a substantially flat rectangular lid having a handle 74 extending from an upper surface of lid 72. Both hopper 62 and a lid 72 are preferably constructed of metal such as steel or aluminum.

Tube assembly 80 further defines a tube assembly comprising a first attach nut 82, a straight tube 84, a valve assembly 86, a second attach nut 92, and an elbow tube 94. Valve assembly 86 further includes a valve 88, and a control lever 90. Elbow tube 94 further includes a threaded end 96, a curved portion 98, a straight portion 100, and a spout 102. Spout 102 and tube assembly 80 preferably have an inner diameter of 0.75 inches but such inner diameter may vary in a range of from 0.125 inches to 2.00 inches. Tube assembly 80 is preferably constructed of metal such as steel, brass, or aluminum. Tube assembly 80 is assembled such that attach nut 82 is threadingly connected to a first end of straight tube 84, a first end of valve assembly 86 is threadingly connected to a second end of straight tube 84, attach nut 92 is threadingly connected to a second end of valve assembly 86, and threaded end 96 of elbow tube 94 is threadingly connected to attach nut 92.

Rear axle assembly 110 further defines an axle assembly comprising a rear axle 112 and a plurality of wheels 114 rotatably attached to rear axle 112. Rear axle assembly 110 is preferably constructed of metal such as steel or aluminum. Wheel 114 preferably defines an inner portion constructed of metal such as steel or aluminum and an outer layer constructed of rubber or plastic.

Swivel casters 120 further defines a caster assembly comprising a caster base 122, a caster shoe 124, and a wheel 126. Caster base 122 and a caster shoe 124 are preferably constructed of metal such as steel or aluminum. Wheel 126 preferably defines an inner portion constructed of metal such as steel or aluminum and an outer layer constructed of rubber or plastic. Caster assembly 120 is assembled such that caster shoe 124 is swivelably attached to caster base 122, and wheel 126 is rotatably attached to caster shoe 124.

Control cable assembly 130 further defines a cable assembly comprising an inner control cable 132 slidingly positioned within a casing 134. Control cable 132 preferably defines a cable comprised of formed metal strands and having a knob 136 on a first and a clevis 138 on a second end. Casing 134 preferably defines an elongated hollow cylindrical casing formed of plastic, a plastic-metal composite, or other material. Control cable assembly 130 further includes a cylindrical metal retainer pin 140 and a formable metal cotter pin 142.

Finish dispensing apparatus 10 is assembled such that handle bar assembly 30 is mounted to chassis assembly 20 by attaching a front end of bar 32 to the vertical portion of frame 24, hopper assembly 60 is mounted to chassis assembly 20 by attaching base plate 69 to bed 22, tube assembly 80 is connected to chassis assembly 20 by bolting tube assembly 80 to support arm 26 by means of large U-bolts 152, tube assembly 80 is connected to hopper assembly 60 by threading attach nut 82 to exit port 70, rear axle assembly 110 is mounted to chassis assembly 20 by rotatable connecting axle 112 to a rear horizontal portion of frame 24, each of a plurality of swivel casters 120 are mounted to chassis assembly 20 by connecting caster bases 122 to a front horizontal portion of frame 24, control cable assembly 130 is connected to handle bar assembly 30 by connecting knob 136 in cable attach hole 48 and by fastening control cable assembly 130 to cable mount bracket 40 by means of small U-bolt 150, control cable assembly 130 is connected to chassis assembly 20 by bolting control cable assembly 130 to support arm 26 by means of small U-bolt 150, control cable assembly 130 is connected to tube assembly 80 by positioning clevis 138 over control lever 90 and by placing retainer pin 140 through both clevis 138 and control lever 90 and by retainably forming cotter pin 142 in retainer pin 140. With finish dispensing apparatus 10 thus assembled, a first movement of lever handle 50 causes a corresponding movement of control lever 90 which in turn causes valve 88 to move from a closed position to an open position, and a second movement of lever handle 50 causes a corresponding movement of control lever 90 which in turn causes valve 88 to move from an open position to a closed position. Furthermore, lesser movements of handle cause corresponding lesser movements or adjustments to valve 88 such that if a liquid finish 160 is contained in hopper assembly 60, a predetermined flow rate of finish 160 is effected. Specifically, when hopper assembly is substantially loaded with a floor finish 160, valve 88 is in an open position, and without auxiliary pressure (i.e. regular atmospheric pressure and gravity feed), a flow rate of approximately 4 gallons per minute (gpm) is achieved, but a flow rate of more or less than 4 gpm is also optionally achieved such as a flow rate falling within a range of 1 to 8 gpm. Further with finish dispensing apparatus 10 thus assembled, apparatus 10 may be moved or rolled over a floor surface 162 by pushing forward, backward, rotationally, or a combination thereof on handle bar assembly 30 to effect corresponding movements of apparatus 10. It is noted that when apparatus 10 is thus assembled and placed on a floor surface 162, a gap 164 is formed between floor surface 162 and spout 102. To minimize splatter of finish 160 when finish 160 is flowing from apparatus 10, and yet to maximize flow of finish 160, gap 164 is preferably 1.75 inches but may be greater or less than 1.75 inches such as a gap falling within a range of 0.25 inches to 6.00 inches. It is further noted that in assembled finish dispensing apparatus 10, the distance from tube straight portion 100 to floor surface 162 is preferably 8.75 inches but may be greater or less than 8.75 inches, the distance from valve 88 to tube straight portion 100 is preferably 2.75 inches but may be greater or less than 2.75 inches such as a distance falling within a range of 1.00 inches to 6.00 inches, and the distance from valve 88 to attach nut 82 is preferably 24.75 inches but may be greater or less than 24.75 inches such as a distance falling within a range of 6.00 inches to 40.0 inches. It is further noted that in assembled finish dispensing apparatus 10, the distance from spout 102 to chassis bed 22 is at least 4.00 inches but may be as much as for instance 36.0 inches or any length therebetween.

In practice, lid 72 is removed from hopper 62 and a quantity of floor finish 160 such as 10 gallons of floor finish 160 is poured into hopper 62. It is noted that depending on the intended work to be performed, most any liquid may optionally be placed in hopper 62. In a preferred embodiment, finish 160 defines ShurGloss 25, Castleguard, or a finish that is compositionally and functionally similar to ShurGloss 25 or Castleguard. Lid 72 is replaced on hopper 62. Lever handle 50 is moved from a closed position to an open position such that the desired flow rate of finish 160 is achieved, and apparatus 10 is moved across floor surface 162 in a generally backward direction leaving a “puddled” trail of a desired quantity in a desired location on a floor surface 162 of a floor that is to be worked. When a sufficient quantity of finish 160 has been dispensed on floor surface 162, lever handle 50 is moved from an open position to a closed open position such that flow of finish 160 is terminated. Apparatus 10 is then positioned or parked at a desired location. By using apparatus 10 in such a method, finish 160 is dispensed on a floor surface 162 without undue exertion or effort on the part of the person performing such dispensing, and without splatter, waste of finish 160, or overspray of finish 160 that are characteristic of other devices and methods. Use of apparatus 10 may further prevent lower back injuries that might otherwise occur from a user repeatedly leaning over a floor and manually pouring finish 160 out of a large bottle.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A fluid dispensing apparatus for use in dispensing floor finish directly onto a floor in large “puddled” quantities for subsequent floor work without spraying, pumping, or splattering said finish and without expressing said finish through filtering or distributing media, said apparatus comprising a wheeled chassis, a storage container having a fluid exit port, a valve, and a dispensing spout, wherein said storage container is mounted to said chassis, a first end of said valve is connect to said fluid exit port, and a second end of said valve is connect to said dispensing spout, and wherein said dispensing spout defines a spout having an inner diameter size within the range of 0.125 inches to 2.00 inches, and wherein when said apparatus is placed on a floor surface with said wheels of said apparatus in contact with said floor surface, a gap is formed between said spout and said floor surface, and wherein said gap defines a gap within the range of 0.25 inches to 6.00 inches

2. The apparatus of claim 1, wherein said spout inner diameter defines an inner diameter size within the range of 0.40 inches to 1.25 inches.

3. The apparatus of claim 1, wherein said gap defines a gap within the range of 1.00 inches to 2.50 inches.

4. The apparatus of claim 1, wherein said apparatus includes a valve control device defining a control cable assembly having a connection end and a lever handle end, and wherein said connection end of said valve control device is connected to said valve such that said lever handle end of said valve control device is positioned a predetermined distance from said valve and such that an adjustment of said lever handle end of said valve control device causes a corresponding adjustment of said valve.

5. The apparatus of claim 1, wherein said storage container defines a hopper having a fluid capacity in the range of two gallons to 25 gallons.

6. The apparatus of claim 1, wherein said storage container dispensably contains a liquid.

7. The apparatus of claim 6, wherein said liquid defines at least one of “SHURGLOSS 25”, “CASTLEGUARD”, and a liquid floor finish other than “SHURGLOSS 25” or “CASTLEGUARD”.

8. The apparatus of claim 1, wherein when said storage container contains a liquid, said apparatus selectively dispenses said liquid at a rate of at least 1 gpm without pressurization by means of gravity feed.

9. The apparatus of claim 1, wherein said spout is located a predetermined distance form said chassis, and wherein said distance is at least 4.0 inches.

10. A fluid dispensing apparatus for use in dispensing floor finish directly onto a floor in large “puddled” quantities for subsequent floor work without spraying, bumping, or splattering said finish and without expressing said finish through filtering or distributing media, said apparatus having an upper end and a lower end and comprising a chassis, a hopper having a liquid exit port, a valve, a dispensing spout, and a valve control device having a connection end and a control end, wherein said hopper is mounted to said chassis, a first end of said valve is connect to said liquid exit port, a second end of said valve is connect to said dispensing spout, and said connection end of said valve control device is connected to said valve such that said control end of said valve control device is positioned a predetermined distance from said valve and such that an adjustment of said control end of said valve control device causes a corresponding adjustment of said valve, and wherein said dispensing spout defines a spout having an inner diameter size within the range of 0.125 inches to 2.00 inches, and wherein when said apparatus is placed on a floor surface such that said apparatus lower end is in contact with said floor surface, a gap is formed between said spout and said floor surface, and wherein said gap defines a gap within the range of 0.25 inches to 6.00 inches.

11. The apparatus of claim 10, wherein said spout inner diameter defines an inner diameter size within the range of 0.50 inches to 1.00 inches.

12. The apparatus of claim 10, wherein said gap defines a gap within the range of 1.25 inches to 2.25 inches.

13. The apparatus of claim 10, wherein said hopper has a fluid capacity in the range of two gallons to 25 gallons.

14. The apparatus of claim 10, wherein said hopper dispensably contains a liquid.

15. The apparatus of claim 14, wherein said liquid defines at least one of “SHURGLOSS 25”, “CASTLEGUARD”, and a liquid floor finish other than “SHURGLOSS 25” or “CASTLEGUARD”.

16. The apparatus of claim 10, wherein when said hopper contains a liquid, said apparatus selectively dispenses said liquid at a rate of at least 1 gpm without pressurization by means of gravity feed.

17. The apparatus of claim 10, wherein said spout is located a predetermined distance from said chassis, and wherein said distance is at least 4.0 inches.

18. A fluid dispensing apparatus for use in dispensing floor finish directly onto a floor in large “puddled” quantities for subsequent floor work without spraying, pumping, or splattering said finish and without expressing said finish through filtering or distributing media, said apparatus comprising a wheeled chassis, a hopper having a liquid exit port, a valve, a dispensing spout, and a valve control device having a connection end and a control end, wherein said hopper is mounted to said chassis, a first end of said valve is connect to said liquid exit port, a second end of said valve is connect to said dispensing spout, and said connection end of said valve control device is connected to said valve such that said control end of said valve control device is positioned a predetermined distance from said valve and such that an adjustment of said control end of said valve control device causes a corresponding adjustment of said valve, and wherein said dispensing spout defines a spout having an inner diameter size within the range of 0.25 inches to 1.50 inches, and wherein when said apparatus is placed on a floor surface with said wheels of said apparatus in contact with said floor surface, a gap is formed between said spout and said floor surface, and wherein said gap defines a gap within the range of 0.50 inches to 2.50 inches.

19. The apparatus of claim 18, wherein said spout inner diameter defines an inner diameter size within the range of 0.50 inches to 1.00 inches.

20. The apparatus of claim 18, wherein said gap defines a gap within the range of 1.25 inches to 2.25 inches.

21. The apparatus of claim 18, wherein said hopper has a fluid capacity in the range of two gallons to 25 gallons.

22. The apparatus of claim 18, wherein said hopper dispensably contains a liquid.

23. The apparatus of claim 22, wherein said liquid defines at least one of “SHURGLOSS 25”, “CASTLEGUARD”, and a liquid floor finish other than “SHURGLOSS 25” or “CASTLEGUARD”.

24. The apparatus of claim 18, wherein when said hopper contains a liquid, said apparatus selectively dispenses said liquid at a rate of at least 1 gpm without pressurization by means of gravity feed.

25. The apparatus of claim 18, wherein said spout is located a predetermined distance form said chassis, and wherein said distance is at least 4.0 inches.
